(19) United States
(12) Patent Application Publication
(10) Pub. No.: US 2016/0225243 A1
(43) Pub. Date: Aug. 4, 2016

(54) FIRE ALARM APPARATUS AND METHOD

(71) Applicants: Liron ALBASS, Moshav Mivtahim (IL); Lior Albass, Moshav Mivtahim (IL)

(72) Inventors: Liron ALBASS, Moshav Mivtahim (IL); Lior Albass, Moshav Mivtahim (IL)

(21) Appl. No.: 14/613,386

(22) Filed: Feb. 4, 2015

(51) Int. Cl. G08B 17/10; G08B 25/10; H04W 4/02

(52) U.S. Cl. CPC G08B 17/10; H04W 4/02; G08B 25/10

(57) ABSTRACT

A fire alarm apparatus (10), comprising: a smoke detector (26), for detecting smoke (44), providing fire indication; a sound alerting component (64), for sounding a sound alert upon the fire indication; a cellular telephony assembly (40), for initiating a cellular communication with another party upon the fire indication; a locating component (28), for providing information on a location of the fire alarm apparatus (10), and transmitting the information to another party via the cellular communication; a switching circuitry (20), for reading from the smoke detector (26) the fire indication, and activating the sound alert, and the cellular communication upon fire indication; a connection to a power source of a building and a battery (24) for permanently powering the fire alarm system; a microphone (66), an amplifier and a speaker (64), for allowing talking via the cellular telephone assembly with people trapped in fire near said alarm apparatus.

### FIELD OF THE INVENTION

The present invention relates to the field of fire alarm systems. More particularly, the invention relates to a method and apparatus for powering the same.

### BACKGROUND OF THE INVENTION

A smoke detector is a device that detects smoke, typically as an indicator of fire. Commercial, industrial, and mass residential devices issue a signal to a fire alarm system, while household detectors, known as smoke alarms, generally issue a local audible or visual alarm from the detector itself.

Smoke detectors in large commercial, industrial, and residential buildings are usually powered by a central fire alarm system, which is powered by the building power with a battery backup. However, in many single family detached and smaller multiple family housings, a smoke alarm is often powered only by a battery.

Smoke detectors powered by the central fire alarm system, which is powered by the building power, may include an automated telephone or other communication means, for alerting far distanced persons or services.

The methods described above have not yet provided satisfactory solutions for strengthening smoke detectors powered by local batteries.

It is an object of the present invention to provide a powerful alerting system by an apparatus which does not require any wiring.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a fire alarm apparatus (10), comprising:
a smoke detector (26), for detecting smoke (44), providing fire indication;
a sound alerting component (64), for sounding a sound alert upon the fire indication;
a cellular telephony assembly (40), for initiating a cellular communication with another party upon the fire indication;
a locating component (28), for providing information on a location of the fire alarm apparatus (10), and transmitting the information to another party via the cellular communication;
a switching circuitry (20), for reading from the smoke detector (26) the fire indication, and activating the sound alert, and the cellular communication upon fire indication;
a connection to a power source of a building and a battery (24) for permanently powering the fire alarm system;
a microphone (66), a sound amplifier and a speaker (64), for allowing talking via the cellular telephone assembly with people trapped in fire near said alarm apparatus.

The cellular telephony assembly (40) may comprise a SIM (subscriber identity module) card (22),

thereby the fire alarm apparatus (10) may comprise a unique identity.

The locating component (28), may obtain the location via a GPS component, a cellular triangulation, a memory component which stores this information in advance, and so on.

The fire alarm apparatus may further comprise:
a memory (62) for storing at least one subscriber identity to be called in the initiated call.

The fire alarm apparatus may further comprise:
a user interface (60), for inputting at least one subscriber identity to be called in the initiated call.

The fire alarm apparatus may further comprise:
a connector (30), for connecting a user interface (60) thereto.

The initiated call may comprise a member selected from a group including: a written message, an SMS (Short Messaging System) message, a vocal message, two-way conversation.

The cellular telephony assembly (40) may further comprise a remote server, for registering activities of the fire alarm apparatus.

The fire alarm apparatus may further comprise:
a pedestal (36), for placing the fire alarm apparatus (10) thereon, for allowing smoke (44) enter through apertures (56) of a package (16) disposed at the bottom of the fire alarm apparatus (10).

The fire alarm apparatus (10) may further comprise:

a delay component (54) being initiated upon the detection of the smoke (44), for operating a dialer (52) of the cellular telephony assembly (40) upon completing a pre-determined delay period, thereby dialing substantially upon completing initialization of the cellular telephony assembly (40).

The reference numbers have been used to point out elements in the embodiments described and illustrated herein, in order to facilitate the

understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 is an exploded view of a fire alarm apparatus according to one embodiment of the present invention.

FIG. 2 is a switching circuitry of the switching circuitry of FIG. 1.

FIG. 3 depicts the use of the fire alarm apparatus of FIG. 1.

FIG. 4 depicts disposition of the fire alarm apparatus of FIG. 1 according to one embodiment.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods,

systems, procedures, components, circuits, and so on, are not described in detail.

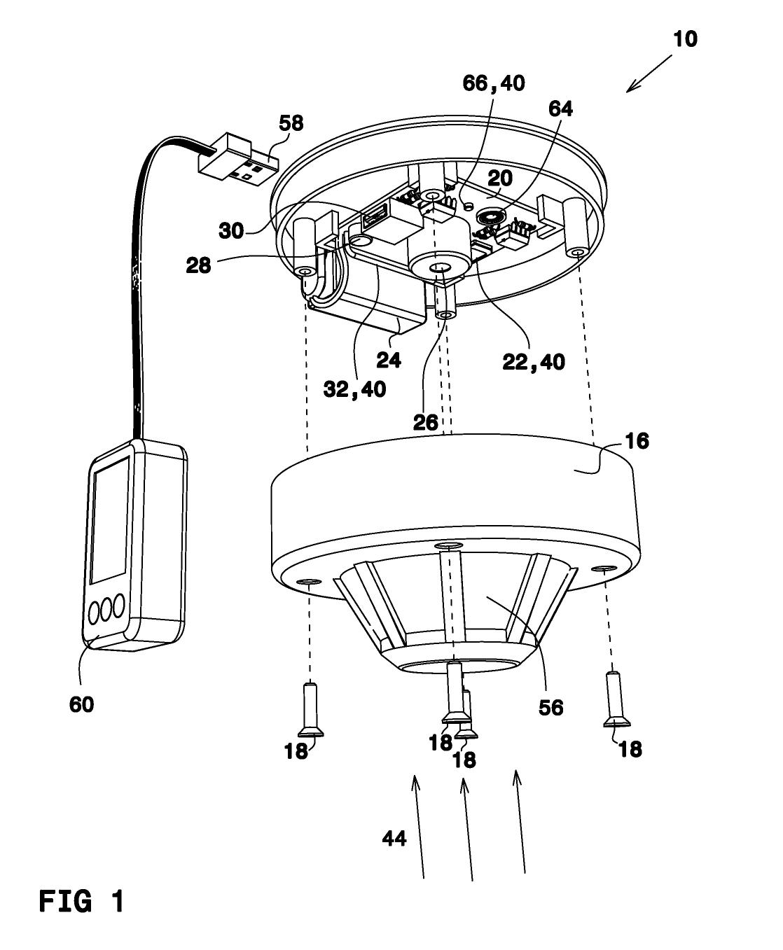

FIG. 1 is an exploded view of a fire alarm apparatus according to one embodiment of the present invention.

A fire alarm apparatus 10 according to one embodiment of the present invention includes a smoke detector 26 receiving smoke 44 through apertures

56 of a package 16, for detecting smoke indicating fire; a cellular telephony assembly 40 for initiating a call upon detecting the smoke; and a battery 24 for powering smoke detector 26 and cellular telephony assembly 40.

The smoke detector may apply optical detection by photoelectric effect, by ionization, or other physical effects.

A subscriber identity module (SIM) is an integrated circuit that securely stores the International Cellular Subscriber Identity

Cellular telephony assembly 40 includes a SIM (subscriber identity module) card 22, thus having a certain address. Thus, upon knowing that the call is received from a certain International Cellular Subscriber Identity being unique, the user knows exactly which fire alarm apparatus signals the alarm.

For example, if a fire extinguishing service receives two calls from two separate fire alarm apparatuses 10, the service can distinguish between them and know the exact location of each alarm, based on the international cellular subscriber identity.

According to another embodiment, fire alarm apparatus 10 includes a locating component 28, such as a Global Positioning System (GPS) component, for informing the location of fire alarm apparatus 10 with the initiated call.

Cellular telephony assembly 40 also includes a transmitter 32, for initiating calls. According to one embodiment, transmitter 32 may include receiving functionality, either for purposes of transmitting, or for using cellular telephony assembly 40 as a full functional telephone for speaking while being active.

According to another embodiment, transmitter 32 may include receiving functionality for receiving instructions upon initiating the call, while turned on.

A speaker 64 may provide vocal alarming in addition to initiating the telephone call.

According to one embodiment, in the initiated call, speaker 64 may constitute the speaker of cellular telephony assembly 40 and microphone 66 may constitute the microphone thereof.

The audio signal sounded by the speaker may be amplified by an amplifier, in order to allow trapped people to talk with a remote center in emergency cases, when screams may be heard in the surrounding.

A connector 30, such as a USB connector, may allow inputting information into a memory 62 for cellular telephony assembly 40 by a user interface 60 ending with a connector 58 fitting connector 30. The information within memory 62 may include one or more subscriber identities that cellular telephony assembly 40 will call to report the smoke incidence. The subscriber identities may include that of the owner and that of the fire extinguishing service.

The information inputted by user interface 60 may further include the contents of the announcement which will be transferred upon calling. The contents may constitute a vocal announcement, such as “Fire Alarm” depending on the language; the contents may further include a written announcement for an SMS (Short Messaging System) message.

Connector 30 may further allow retrieving information from memory 62, which may include the history of smoke occurrences.

Connector 30, such as the USB connector, may further allow recharging battery 24 from an external power source. According to one embodiment, user interface 60 may include the external power source.

Many residential smoke detectors are being sold with batteries that can run for about 7 to 10 years. However, battery 24 is not capable of powering telephony assembly 40 for more than several days.

The solution for this problem is that cellular telephony assembly 40 is normally turned to off by a switching circuitry 20. Only upon detecting smoke does switching circuitry 20 activate cellular telephony assembly 40.

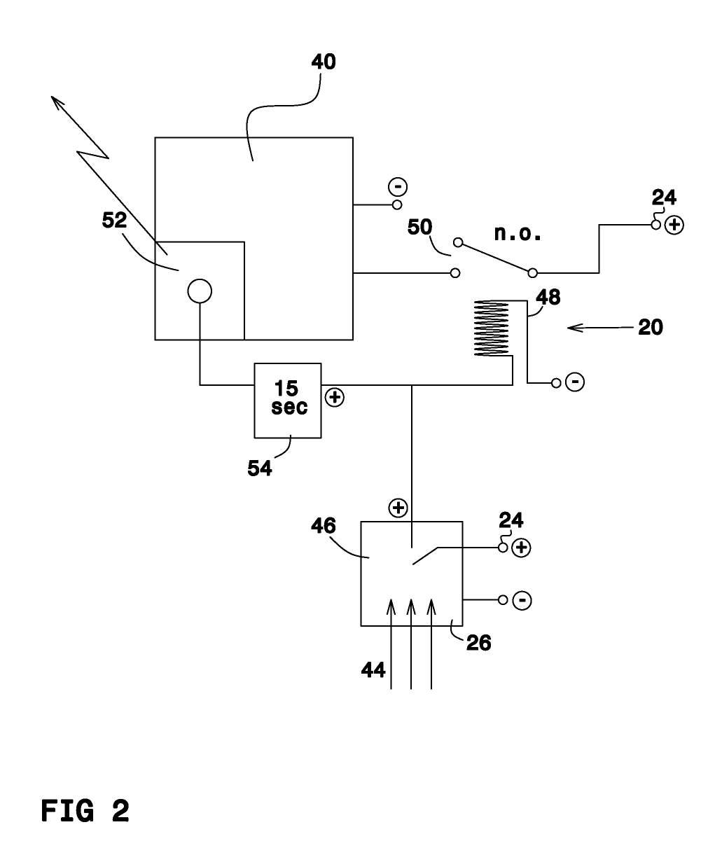

FIG. 2 is a switching circuitry of the switching circuitry of FIG. 1.

In the switching circuitry 20, smoke detector 26 is connected permanently for being powered permanently by battery 24. Upon receiving smoke 44, smoke detector 26 closes a switch 46 representing the operation of the smoke detector; switch 46 may be an electronic switch or a signal; as well, it may be a mechanical switch. Switch 46 upon closing energizes a relay 48 closing a switch 50 thereof, which provides power from battery 24 to cellular telephony assembly 40 for turning it on.

Switch 50 of relay 48 also provides power from battery 24 to initiate a delay component 54, which after a pre-determined delay period, e.g., about 15 seconds, operates the dialer 52 of cellular telephony assembly 40.

Delay component 54, being initiated upon the detection of smoke 44, operates dialer 52 upon completing the pre-determined delay period.

Thus, upon turning cellular telephony assembly 40 to on, it runs the initialization's normal procedure, which takes about 15 seconds, and upon completing the initialization, the dialer 52 of telephony assembly 40 dials to one or more pre-determined addresses.

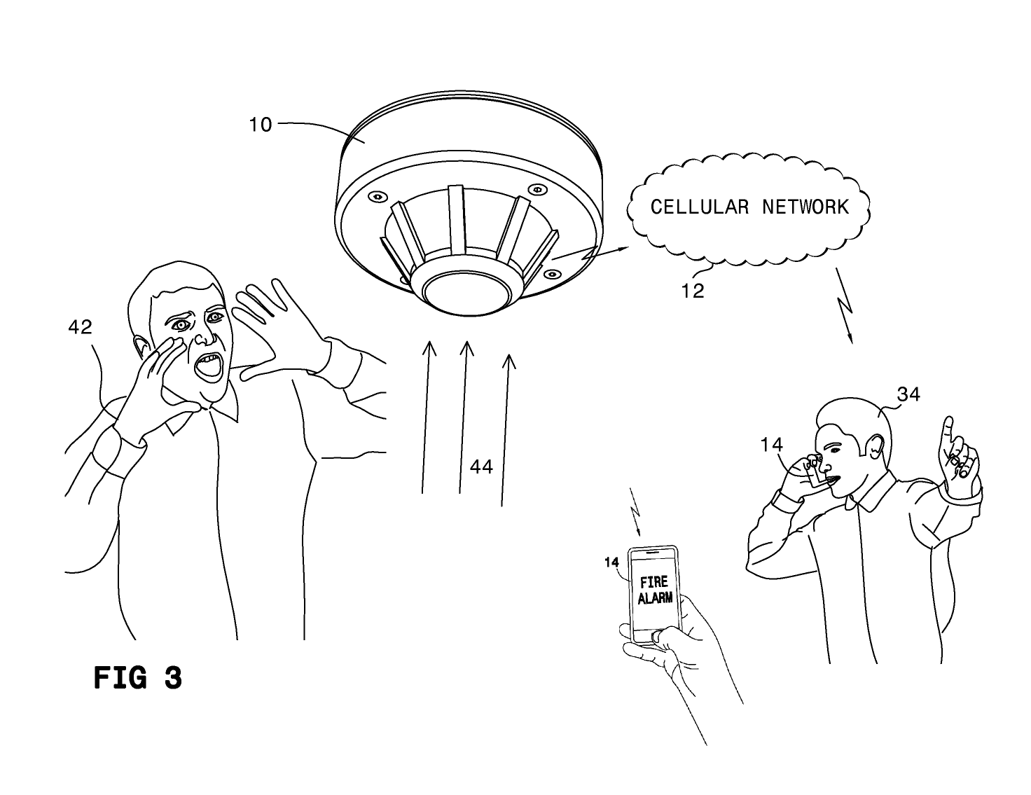

FIG. 3 depicts the use of the fire alarm apparatus of FIG. 1.

Fire alarm apparatus 10, upon detecting smoke 44, is capable of dialing through a cellular network 12 or other wireless network providing long range communication to a telephone 14 or another Personal Digital Assistant (PDA).

This capability of direct dialing to telephone 14 allows telephony assembly 40 to send an SMS (Short Messaging System) message to telephone 14, such as s depicted on the screen of telephone 14: “Fire Alarm”.

According to one embodiment, the person 34 using telephone 14 may utilize cellular telephony assembly 40 while active, for speaking with a person 42 being proximate to fire alarm apparatus 10. Person 42, shown in the figure urging “help”, speaks into microphone 66 and listens to speaker 64, thus cellular telephony assembly 40 provides a two-way conversation. The sounded vocal signals can be amplified by an amplifier, therefore clearly heard in emergency situations where trapped people may scream. Person 34, who may be of the fire extinguishing service, is able to instruct person 42 located at the fire site.

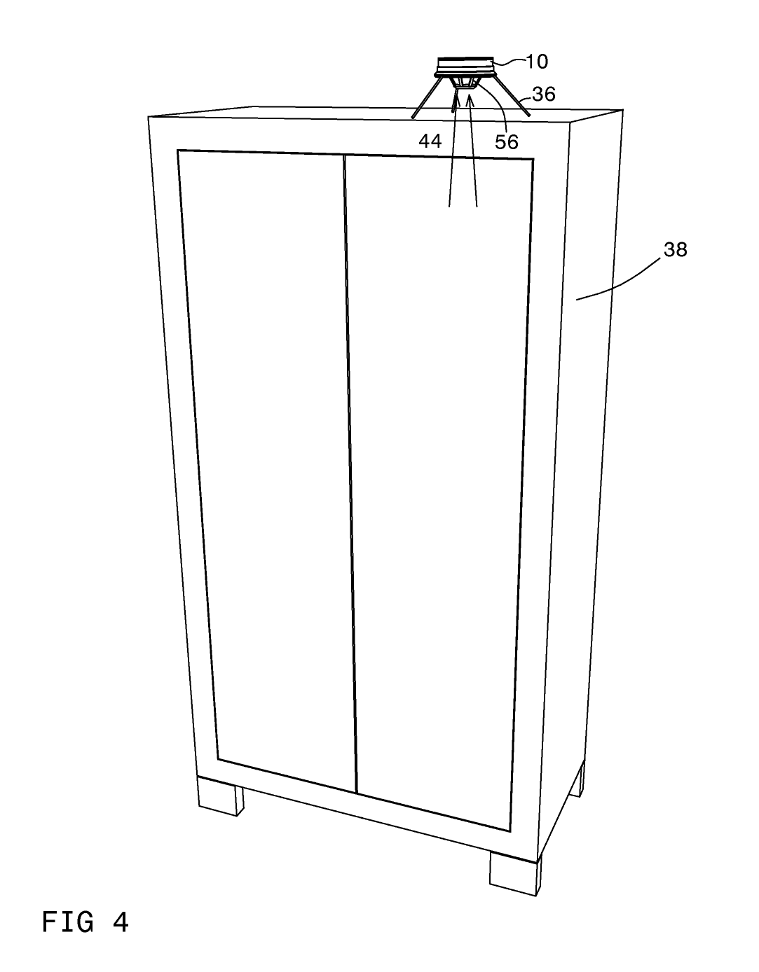

FIG. 4 depicts disposition of the fire alarm apparatus of FIG. 1, according to one embodiment.

Fire alarm apparatus 10 is an independent component, containing both the power supply by battery 24, and long range communication capabilities for warning of the detection of smoke 44.

Thus, fire alarm apparatus 10 does not require any installation. FIG. 4 depicts fire alarm apparatus 10 placed on a pedestal 36 at the top of a cupboard or a shelf 44. Pedestal 36 provides a space between the top of cupboard 38 and apertures 56 and package 16, for allowing smoke 44 to enter through apertures 56, being disposed at the bottom of fire alarm apparatus 10.

In the figures and/or description herein, the following reference numerals have been mentioned:
numeral 10 denotes a fire alarm apparatus according to one embodiment of the present invention;
numeral 12 denotes a cellular network or other wireless network providing long range communication;
numeral 14 denotes a telephone of a user, to which the fire alarm apparatus calls for warning of a fire hazard;
numeral 16 denotes a package of the fire alarm apparatus; said package allowing smoke to enter;
numeral 18 denotes a screw for closing the package of the fire alarm apparatus;
numeral 20 denotes a switching circuitry, for turning the cellular telephony assembly to on upon detecting smoke,
and for turning the cellular telephony assembly to off otherwise;
numeral 22 denotes a SIM (subscriber identity module) card of the cellular telephony assembly;
numeral 24 denotes a battery; the battery normally is not charged, and thus must be capable of powering the smoke detector and the cellular telephony assembly for a relatively long period;
numeral 26 denotes a smoke detector, according to which the switching circuitry turns the cellular telephony assembly to on or to off;
numeral 28 denotes a locating component, such as a Global Positioning System (GPS) component, for obtaining the location of the fire alarm apparatus;
numeral 30 denotes a connector of the fire alarm apparatus for inputting and outputting information, and optionally for recharging the battery;
numeral 32 denotes a transmitter of the cellular telephony assembly, for making calls;
numeral 34 denotes a person dispatched for rescue;
numeral 36 denotes a pedestal for disposing the fire alarm apparatus thereon;
numeral 38 denotes a cupboard or a shelf;
numeral 40 denotes a cellular telephony assembly, being any assembly capable of calling via cellular communication or other long range wireless network;
numeral 42 denotes a person asking for help;
numeral 44 denotes smoke, indicating fire;
numeral 46 denotes a switch representing the operation of the smoke detector, according to one embodiment;
numeral 48 denotes a relay;
numeral 50 denotes a switch of a relay;
numeral 52 denotes a dialer of the telephony assembly; upon actuation, it dials a number which may be stored in the memory;
numeral 54 denotes a delay component;
numeral 56 denotes an aperture in the package of the fire alarm apparatus, providing entrance of the smoke;
numeral 58 denotes a connector within the fire alarm apparatus;
numeral 60 denotes a user interface;
numeral 62 denotes a memory storing the predetermined subscriber numbers to call, upon detecting smoke;
numeral 64 denotes a speaker, either being a separate component or of the cellular telephony assembly; the audio signal sounded by the speaker may be amplified by an amplifier; and
numeral 66 denotes a microphone of the cellular telephony assembly.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof.

These reference numbers should not be interpreted as limiting the claims in any form.

What is claimed is:

1. A fire alarm apparatus (10) comprising:
a smoke detector (26), for detecting smoke (44), providing fire indication;
a sound alerting component (64), for sounding a sound alert upon said fire indication;
a cellular telephony assembly (40), for initiating a cellular communication with another party upon said fire indication;
a locating component (28), for providing information on a location of said fire alarm apparatus (10), and transmitting said information to said another party via said cellular communication;
a switching circuitry (20), for reading from said smoke detector (26) said fire indication, and activating said sound alert, and said cellular communication upon fire indication;
a connection to a power source of a building and a battery (24) for permanently powering said fire alarm system;
a microphone (66), an amplifier and a speaker (64), for allowing talking via said cellular telephone assembly with people trapped in fire near said alarm apparatus.

2. A fire alarm apparatus (10) according to claim 1, wherein said cellular telephony assembly (40) comprises a SIM (subscriber identity module) card (22),
thereby said fire alarm apparatus (10) comprises a unique identity.

3. A fire alarm apparatus (10) according to claim 1, wherein said location component is obtained from on GPS component.

4. A fire alarm apparatus (10) according to claim 1, wherein said location component is obtained by a cellular triangulation.

5. A fire alarm apparatus (10) according to claim 1, wherein said location component is obtained from a memory storing information of a location thereof.

6. A fire alarm apparatus (10) according to claim 1, further comprising:
a memory (62) for storing at least one subscriber identity to be called in said initiated call.

7. A fire alarm apparatus (10) according to claim 1, further comprising:
a user interface (60), for inputting at least one subscriber identity to be called in said initiated call.

8. A fire alarm apparatus (10) according to claim 1, further comprising:
a connector (30), for connecting a user interface (60) thereto.

9. A fire alarm apparatus (10) according to claim 1, wherein said initiated call comprises a member selected from a group including: a written message, an SMS (Short Messaging System) message, a vocal message, two-way conversation.

10. A fire alarm apparatus (10) according to claim 1, further comprising a remote server, for registering activities of said fire alarm apparatus.

11. A fire alarm apparatus (10) according to claim 1, further comprising:
a pedestal (36), for placing said fire alarm apparatus (10) thereon, for allowing smoke (44) to enter through apertures (56) of a package (16) disposed at the bottom of said fire alarm apparatus (10).

12. A fire alarm apparatus (10) according to claim 1, further comprising:
a delay component (54) being initiated upon said detection of the smoke (44), for operating a dialer (52) of said cellular telephony assembly (40) upon completing a pre-determined delay period,
thereby dialing substantially upon completing initialization of said cellular telephony assembly (40).
